(19) United States
(12) Patent Application Publication
(10) Pub. No.: US 2004/0102069 A1
(43) Pub. Date: May 27, 2004

(54) Hydraulic connector

(76) Inventors: Shiva P. Singeetham, Houston, TX (US); Jon Buck, Tomball, TX (US); Ashley Oatman, Houston, TX (US)

Correspondence Address: J. Mike Amerson, Williams, Morgan & Amerson, P.C., Suite 1100, 10333 Richmond, Houston, TX, 77042, US

(21) Appl. No.: 10/717,957

(22) Filed: Nov. 20, 2003

Related U.S. Application Data
(60) Provisional application No. 60/428,112, filed on Nov. 21, 2002.

(51) Int. Cl. H01R 13/62

(52) U.S. Cl. 439/157

(57) ABSTRACT

The present invention is directed to a hydraulic connector. In one illustrative embodiment, the hydraulic connector comprises a first end adapted to be coupled to a first component, a plurality of locking segments that, when actuated, are adapted to secure the first component to a second component, and a locking mandrel that, when actuated, is adapted to engage each of the plurality of locking segments at at least three discrete, spaced apart engagement areas.

### BACKGROUND OF THE INVENTION

1. Field of the Invention

The present invention is generally related to hydraulic connectors, and, more particularly, to hydraulic connectors that may be employed to connect various components together. In various illustrative embodiments, the connector disclosed herein may be used as a wellhead, riser or flowline connector.

2. Description of the Related Art

In drilling and producing from offshore oil and gas wells, it is often necessary to connect two components or tubular bodies to one another at a substantial distance beneath the surface of the water. For example, a blowout preventer or a production tree may need to be operatively coupled to a wellhead through use of a hydraulic connector that may be engaged or disengaged by the application of hydraulic pressure that is controlled from the surface platform.

A variety of hydraulically actuated wellhead connectors presently exist within the industry. Such connectors typically involve the use of latches, collet fingers, locking rings, etc. that are used to connect and disconnect the various components. In some cases, one or more tapered interfaces are provided between a lock ring and each of a plurality of collets such that, when the lock ring is forced downward by the application of hydraulic pressure, the lock ring urges the collets into the desired engagement with one or more of the components to be connected together. Of course, the exact configuration of such connectors may vary. However, in the case where the interaction between tapered surfaces is involved, a mechanism or means is typically used to insure that the engaged tapered surfaces do not disengage or loosen. For example, once the connector is actuated and properly engaged, hydraulic pressure may be continually applied to the connector to prevent disengagement of the tapered surfaces. In other cases, a separate lock pin or structure may be used to prevent disengagement of the engaged tapered surfaces.

In other configurations, hydraulic connectors are configured such that a substantially flat interface, i.e., a non-tapered interface, is provided between the lock ring and collet fingers. However, hydraulic connectors configured in this manner typically employ a preload ring to insure, among other things, that the interface between the two components is properly preloaded. Such preloading assists in maintaining the integrity of the interface between the two components when they are subjected to various loading conditions during normal operations.

The present invention is directed to an apparatus and methods for solving, or at least reducing the effects of, some or all of the aforementioned problems.

### SUMMARY OF THE INVENTION

The present invention is directed to a hydraulic connector. In one illustrative embodiment, the hydraulic connector comprises a first end adapted to be coupled to a first component, a plurality of locking segments that, when actuated, are adapted to secure the first component to a second component, and a locking mandrel that, when actuated, is adapted to engage each of the plurality of locking segments at at least three discrete, spaced apart engagement areas.

In another illustrative embodiment, the hydraulic connector comprises a first end adapted to be coupled to a first component, a plurality of locking segments that, when actuated, are adapted to secure the first component to a second component, and a locking mandrel that, when actuated, is adapted to engage each of the plurality of locking segments at at least two discrete, spaced apart substantially flat engagement areas.

In yet another illustrative embodiment, the hydraulic connector comprises a first end adapted to be coupled to a first component, a plurality of locking segments that, when actuated, are adapted to secure the first component to a second component, and a locking mandrel that, when actuated, is adapted to engage each of the plurality of locking segments at three substantially flat engagement areas.

In a further illustrative embodiment, the hydraulic connector comprises a first end adapted to be coupled to a first component, a plurality of locking segments that, when actuated, are adapted to secure the first component to a second component, wherein each of the plurality of locking segments comprises a first primary locking shoulder that is adapted to engage a surface on the first component and a second primary locking shoulder that is adapted to engage a surface on the second component, and a locking mandrel that, when actuated, is adapted to engage each of the plurality of locking segments at three substantially flat engagement areas.

### BRIEF DESCRIPTION OF THE DRAWINGS

The invention may be understood by reference to the following description taken in conjunction with the accompanying drawings, in which like reference numerals identify like elements, and in which:

FIG. 1A is a cross-sectional view of a connector in accordance with one illustrative embodiment of the present invention;

FIG. 1B is a plan view of the illustrative connector depicted in FIG. 1A;

FIG. 2A is a cross-sectional view of an illustrative connector in the locked position;

FIG. 2B is a cross-sectional view of an illustrative connector in the unlocked position;

FIG. 2C is a cross-sectional view of an illustrative connector in the unlocked position with a secondary release piston actuated; and

FIG. 2D is a cross-sectional, spaced apart view of an illustrative locking segment and locking mandrel in accordance with one illustrative embodiment of the present invention.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF THE INVENTION

Illustrative embodiments of the invention are described below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The present invention will now be described with reference to the attached figures. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

In general, the connector of the present invention may be employed to connect two components to one another. As will be recognized by those skilled in the art after a complete reading of the present application, the present invention has broad applicability with respect to the connection of various components to one another. For example, the connector of the present invention may be employed to connect various components, such as a blowout preventer, a production tree, a riser, a tubing head, a running tool, etc. to a subsea wellhead. The present invention may also be employed, if desired, to connect riser sections to one another. For ease of explanation, the present invention will be disclosed in the context of connecting a generic component to a subsea wellhead. However, the present invention should not be considered as limited to connecting any specific components to one another, unless such components are expressly recited in the appended claims.

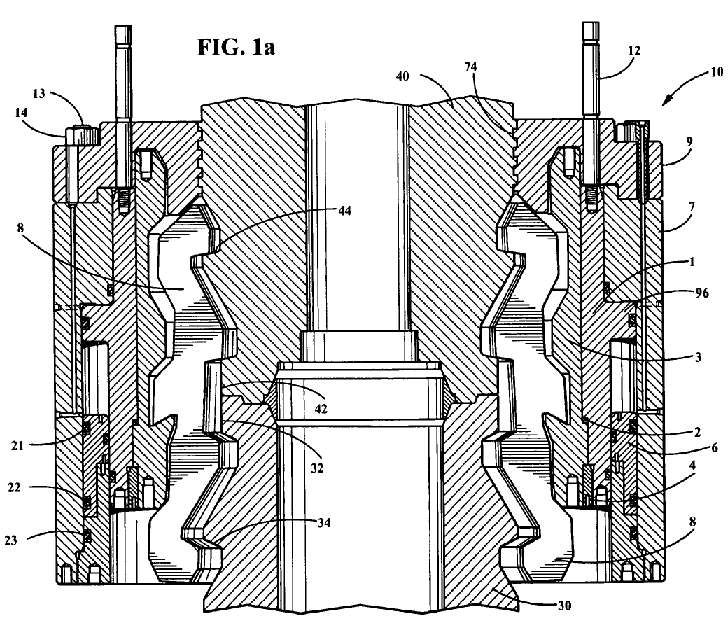

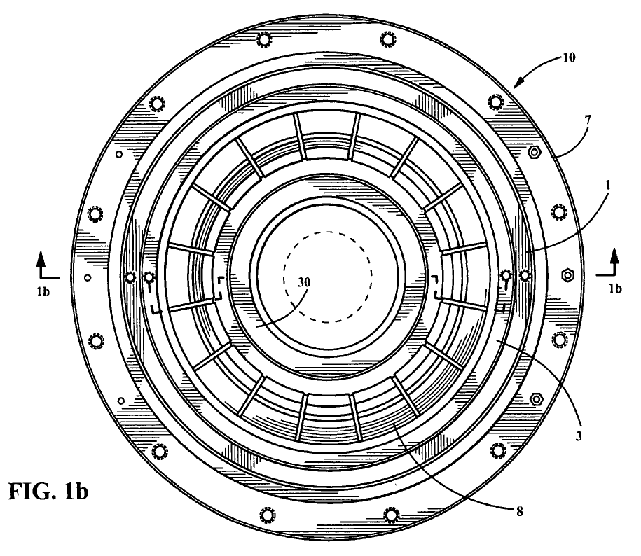

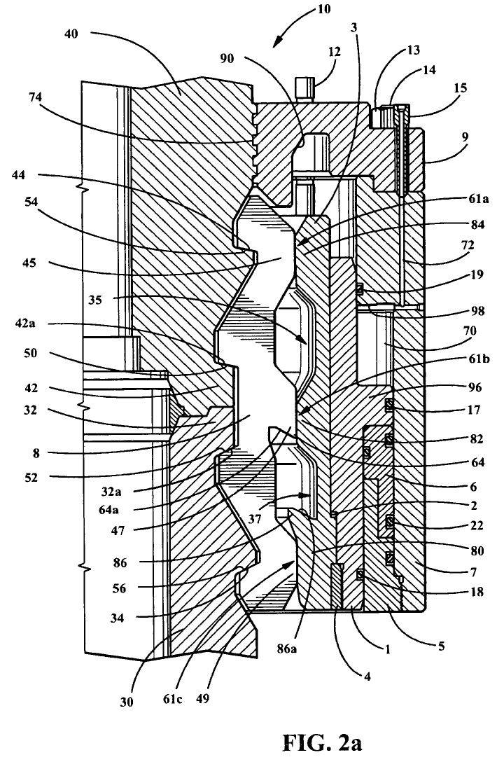

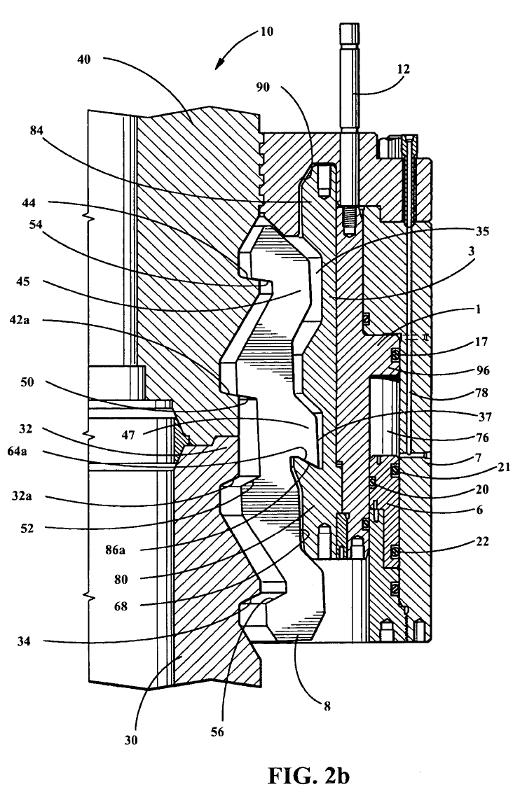

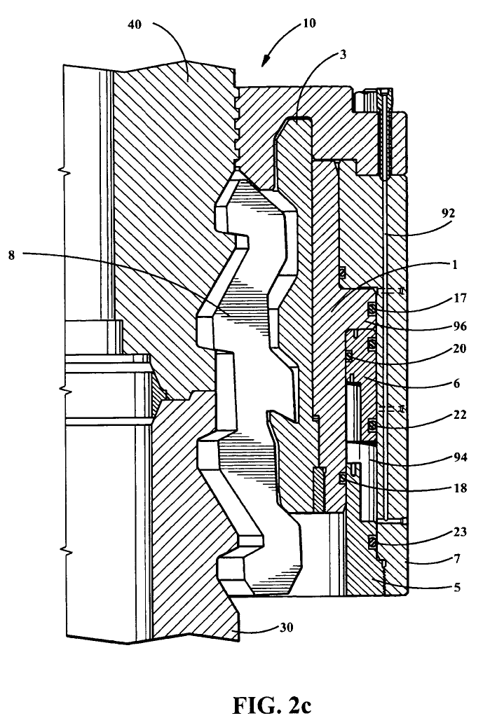

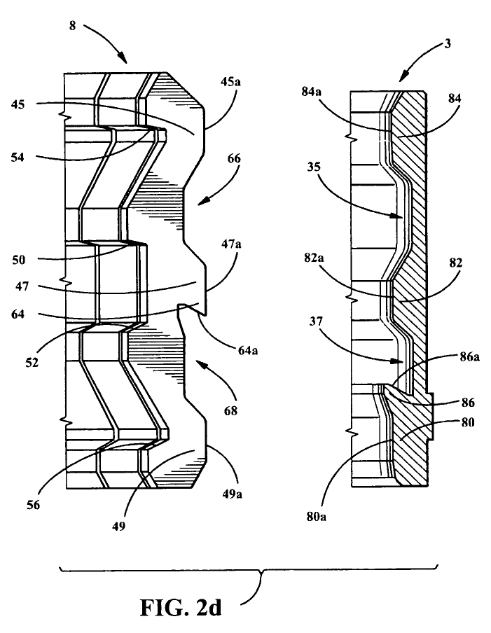

Referring to FIG. 1, an illustrative embodiment of the connector 10 includes an upper body portion 9, which is coupled to a first component 40, e.g., a tubing head or other subsea component, generally at 74. In the disclosed embodiment, the upper body portion 9 is threadingly coupled to the first component 40. However, the upper body portion 9 could be coupled to the first component 40 using other known techniques, e.g., by a plurality of threaded bolts (not shown). The connector 10 further comprises an outer body portion 7 that includes an inner shoulder 98 (see FIG. 2a). The outer body portion 7 is attached to the upper body portion 9 via studs 13 and nuts 14. Disposed within the outer body portion 9 is a primary piston 1, which includes an outwardly facing lip 96. A secondary release piston 6 is disposed between the outer body portion 7 and the primary piston 1. A lower retaining ring 5 (see FIG. 2A) is disposed below the secondary release piston 6, and is threadingly coupled to the inside diameter of the outer body portion 7. A locking mandrel 3 is disposed adjacent the primary piston 1, and is secured thereto via a shoulder and bearing ring 2 and a locking mandrel retainer 4. One or more indicator rods 12 are coupled to the top of the primary piston 1, and extend through the upper body portion 9 so that they are visible from the outside of the connector 10. In the disclosed embodiment, the indicator rods 12 are threaded into the primary piston body 1.

A plurality of locking segments 8 are retained between the first component 40, e.g., a tubing head, and the locking mandrel 3. The number and physical size of the locking segments 8 employed may vary depending upon, among other things, the physical size of the components to be coupled to one another and the anticipated loadings on the completed connection. In one illustrative embodiment, the connector 10 may comprise approximately 16 of the locking segments 8. Each of the locking segments 8 may have a radial thickness of, for example, 1.5-2.0 inches and a circumferential width of approximately 5.0-5.5 inches. In FIG. 1, as well as FIG. 2b, the connector 10 is shown in the unlocked position. In this unlocked position, the first component 40 with the connector 10 attached thereto can be installed onto or removed from a second component 30, e.g., a wellhead or other well component.

Referring to FIG. 2a, the connector 10 is shown in the locked position, wherein the first component 40 is securely connected to the second component 30. A locking piston chamber 70 is formed between an inner shoulder 98 of the outer body portion 7 and the lip 96. Seals 19 and 17 are provided between the outer body portion 7 and the primary piston 1 above and below the chamber 70 to isolate the chamber 70. The upper body portion 9 includes a downwardly facing recess 90. The first component 40, e.g., tubing head, comprises a hub 42, a primary shoulder 42a and a secondary shoulder 44. Similarly, the second component 30, e.g., wellhead, comprises a hub 32, a primary shoulder 32a and a secondary shoulder 34. Each of the locking segments 8 comprises upper, central and lower OD protrusions 45, 47 and 49, respectively. The central OD protrusion 47 comprises a downwardly facing tooth 64 having a tapered engagement surface 64a. Each locking segment 8 further comprises upper and lower primary locking shoulders 50 and 52, respectively, and upper and lower secondary locking shoulders 54 and 56, respectively. The locking mandrel 3 comprises upper, central and lower ID protrusions 84, 82 and 80, respectively. The lower ID protrusion 80 comprises an upwardly facing tooth 86 having a tapered engagement surface 86a. The locking mandrel 3 further comprises an upper ID recess 35 and a lower ID recess 37 (see FIG. 2d). The locking segment 8 further comprises an upper OD recess 66 and a lower OD recess 68 (see FIG. 2d).

When it is desired to actuate the connector 10 from the unlocked to the locked position, hydraulic fluid is introduced into a chamber 70 via a pipe nipple 15 and a flow passage 72 in the outer body portion 7. As the locking piston chamber 70 becomes pressurized, the primary piston 1 and the locking mandrel 3 are forced downward relative to the outer body portion 7. Upper secondary shoulders 54 on locking segments 8 are landed on the upper secondary shoulder 44 on the first component 40, preventing downward movement of the locking segments 8. As the locking mandrel 3 moves downward, the ID protrusions 84, 82 and 80 on the locking mandrel 3 engage the OD protrusions 45, 47 and 49, respectively, of the locking segments 8, forcing the locking segments 8 radially inward and slightly upward due to the shape of the tapered surface 44. Thus, the primary shoulder 50 of the locking segment 8 engages the surface 42a on the hub 42, the primary shoulder 52 engages the surface 32a on the hub 32, and the secondary shoulder 56 engages the secondary shoulder 34 on the second component 30. Thus, the first and second components 40, 30 are securely connected together. Proper actuation of the primary piston 1 can be confirmed by observing the position of the indicator rod 12.

Referring to FIG. 2b, the connector 10 is shown in the unlocked position. A primary releasing piston chamber 76 is formed between the secondary release piston 6 and the lip 96 on the primary piston 1. A seal 20 is provided between the secondary release piston 6 and the primary piston 1, and a seal 21 is provided between the secondary release piston 6 and the outer body portion 7. The seals 20 and 21 cooperate with the seal 17 to isolate the chamber 76.

When it is desired to actuate the connector 10 from the locked to the unlocked position, hydraulic fluid is introduced into the primary releasing piston chamber 76 via the flow passage 78 in the outer body portion 7. As the chamber 76 becomes pressurized, the primary piston 1 and the lock mandrel 3 are forced upward. As the locking mandrel 3 moves upward relative to the locking segments 8, the ID protrusions 84, 82 and 80 on the locking mandrel 3 disengage from the OD protrusions 45, 47 and 49, respectively, on the locking segments 8. As the locking mandrel 3 is raised further, the upwardly facing tapered surface 86a on the protrusion or tooth 86 on the locking mandrel 3 engages the downwardly facing tapered surface 64a on the tooth 64 on the locking segments 8. The teeth 86 and 64 cooperate to cam the locking segments 8 radially outward and away from the first and second components 40, 30. As the locking segments 8 move outward, the central OD protrusion 47 on the locking segments 8 is received in the lower ID recess 37 on the locking mandrel 3. Similarly, the upper OD protrusion 45 is received in the upper ID recess 35. The upper end of the locking mandrel 3, including the upper ID protrusion 84, is received in a recess 90 in the upper body portion 9. Proper actuation of the primary piston 1 can be confirmed by observing the position of the indicator rod 12.

Referring to FIG. 2c, a backup method for unlocking the connector 10 is provided. A secondary release piston chamber 94 is formed between the secondary release piston 6 and the lower retainer ring 5. A seal 18 is provided between the lower retainer ring 5 and the primary piston 1. A seal 23 is provided between the lower retainer ring 5 and the outer body portion 7. A seal 22 is provided between the outer body portion 7 and the secondary release piston 6. The seals 18, 22 and 23 cooperate to isolate the chamber 94. In the event that the primary release piston chamber 76 cannot be pressurized (due to hydraulic failure, seal failure, or other reason), the secondary release piston 6 may be used to unlock the connector 10 as follows. Hydraulic fluid is introduced into the chamber 94 via a flow passage 92. As the chamber 94 becomes pressurized, the secondary release piston 6 is forced upward. The secondary release piston 6 engages the lip 96 on the primary piston 1, thus forcing the primary piston 1 upward and unlocking the connector 10 as previously described. Proper actuation of the secondary release piston 6 can be confirmed by observing the position of the indicator rod 12. It should be noted that, in general, the various seals depicted herein, e.g., seals 17, 18, 20, 22, may be any type of seal that is capable of providing the sealing functions described herein.

In one aspect, the present invention is directed to a connector 10 wherein the locking mandrel 3 engages the locking segments 8 at three discrete, axially spaced apart locations, i.e., engagement areas 61a, 61b and 61c. See, e.g., FIGS. 2a and 2d. That is, in one illustrative embodiment, the engagement areas 61a, 61b and 61c are, respectively, defined by the engagement of the surfaces 45a-84a, 47a-82a and 49a-80a. The axial length of the engagement areas may vary depending upon the particular application, e.g., from 1-3 inches. In one embodiment, the connector 10 of the present invention provides an engagement area 61b between the locking segments 8 and the locking mandrel 3 at an axial location that is proximate the interface between the first and second components 40, 30, and engagement areas 61a and 61c at spaced apart locations above and below the interface between the first and second components 40, 30. Thus, the connector 10 of the present invention provides more uniform loading of the connection between the two components 40, 30 since the loads are more evenly distributed throughout the connector 10 and the various components 40, 30.

In the depicted embodiment, each of the engagement areas 61a, 61b and 61c are defined by the engagement of substantially flat, i.e., non-tapered, surfaces. However, if desired, one or more of the three discrete, axially spaced apart engagement areas may be defined by the engagement of tapered surfaces. For example, the engagement surfaces that define the central engagement area 61b, i.e., the surfaces 47a and 82a, may be tapered surfaces, while the upper and lower engagement areas 61a and 61c may be defined by the engagement of substantially flat engagement surfaces. Alternatively, the central engagement area 61b may have substantially flat engagement surfaces (47a, 82a) while the upper and lower engagement areas 61a and 61c employ tapered engagement surfaces. Thus, the present invention should not be considered as limited to whether the engagement surfaces between the locking segments 8 and the locking mandrel 3 are substantially flat or tapered, unless such limitations are expressly set forth in the appended claims. As used herein, the term “flat” or “substantially flat” should be understood to be a surface that is substantially parallel to the axis of the mated first and second components 40, 30. Exact flatness in an absolute sense is not required, as such terms should be understood to encompass surfaces that may not be precisely flat due to such things as manufacturing tolerances.

Another novel aspect of the present invention is that the locking mandrel 3 is actuated by a physically separate actuation means, i.e., primary piston 1. The primary piston 1 and the locking mandrel 3 are coupled to one another via the bearing ring 2 and the locking mandrel retainer 4 (see FIG. 1A). Such a configuration is in contrast with connectors wherein the mandrel 3 is merely part of an overall actuating assembly, e.g., part of a piston assembly. Separating the locking mandrel 3 from the primary piston 1 may provide several advantages. For example, the locking mandrel 3 becomes less massive as compared to other systems where the locking mandrel is merely part of a larger component. In turn, this may provide a more flexible connector that is able to more readily accommodate manufacturing tolerances of the various engaged components and/or variations in loading of the components 30, 40, the locking segments 8 and the locking mandrel 3. Additionally, by employing a locking mandrel 3 that is physically separate from its actuating mechanism, different actuating mechanisms may be employed to actuate the locking mandrel 3. For example, although not depicted in the drawings, a downhole tool could be used to actuate the mandrel 3 and thereafter be returned to the surface. Other benefits associated with providing a physically separate locking mandrel 3 and primary piston 1 will be recognized by those skilled in the art after a complete reading of the present application.

The present invention is directed to a hydraulic connector. In one illustrative embodiment where the engagement areas of the present connector are defined by the engagement of substantially flat surfaces, the connector provides for a more secure and stable connection. That is, engaged substantially flat surfaces do not have a tendency to separate, as do tapered engagement surfaces. Thus, some embodiments of the present invention, i.e., those employing only substantially flat engagement areas, may avoid the use of constant hydraulic pressure used on various locking mechanisms to insure that the mated connection does not loosen during operation. Of course, if desired, additional locking mechanisms may be employed with the present invention to provide additional assurance that the connector does not loosen once it has been properly installed.

In one illustrative embodiment, the hydraulic connector comprises a first end adapted to be coupled to a first component, a plurality of locking segments that, when actuated, are adapted to secure the first component to a second component, and a locking mandrel that, when actuated, is adapted to engage each of the plurality of locking segments at at least three discrete, spaced apart engagement areas.

In another illustrative embodiment, the hydraulic connector comprises a first end adapted to be coupled to a first component, a plurality of locking segments that, when actuated, are adapted to secure the first component to a second component, and a locking mandrel that, when actuated, is adapted to engage each of the plurality of locking segments at at least two discrete, spaced apart substantially flat engagement areas.

In yet another illustrative embodiment, the hydraulic connector comprises a first end adapted to be coupled to a first component, a plurality of locking segments that, when actuated, are adapted to secure the first component to a second component, and a locking mandrel that, when actuated, is adapted to engage each of the plurality of locking segments at three substantially flat engagement areas.

In a further illustrative embodiment, the hydraulic connector comprises a first end adapted to be coupled to a first component, a plurality of locking segments that, when actuated, are adapted to secure the first component to a second component, wherein each of the plurality of locking segments comprises a first primary locking shoulder that is adapted to engage a surface on the first component and a second primary locking shoulder that is adapted to engage a surface on the second component, and a locking mandrel that, when actuated, is adapted to engage each of the plurality of locking segments at three substantially flat engagement areas.

In another illustrative embodiment, a connector of the present invention is comprised of a first end adapted to be connected to a first component, a plurality of means for securing the first component to a second component, and means for engaging each of the means for securing the first component to the second component at at least three discrete, spaced apart engagement areas. In one illustrative embodiment, the plurality of means for securing the first component and the second component comprise a plurality of locking segments 8 disclosed in the specification, and the means for engaging comprises at least the locking mandrel 3. In further embodiments, the connector comprises a means for actuating the means for engaging the plurality of securing means. In the disclosed embodiment, the means for actuating is comprised of at least the primary piston 1. In an even further embodiment, the connector is comprised of a secondary means for disengaging the means for engaging each of the means for securing the first component to the second component. In one embodiment, the secondary means for disengaging is comprised of at least the secondary release piston 6.

The present invention is also directed to novel methods of using the present invention. For example, in one illustrative embodiment, the method comprises coupling a first end of the connector to a first component, positioning the connector around a portion of a second component, actuating a locking mandrel to thereby engage each of a plurality of locking segments at at least three discrete, spaced apart engagement areas, thereby urging each of the locking segments into engagement with the first and second components to thereby secure the first component to the second component. In one illustrative embodiment, the method more specifically involves actuating the locking mandrel such that it engages each of the plurality of locking segments at three substantially flat engagement areas.

The particular embodiments disclosed above are illustrative only, as the invention may be modified and practiced in different but equivalent manners apparent to those skilled in the art having the benefit of the teachings herein. For example, the process steps set forth above may be performed in a different order. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

What is claimed:

1. A connector, comprising:
a first end adapted to be coupled to a first component;
a plurality of locking segments that, when actuated, are adapted to secure said first component to a second component; and
a locking mandrel that, when actuated, is adapted to engage each of said plurality of locking segments at at least three discrete, spaced apart engagement areas.

2. The connector of claim 1, wherein at least one of said engagement areas is a substantially flat engagement area defined by the engagement of substantially flat surfaces.

3. The connector of claim 1, wherein all of said engagement areas are substantially flat engagement areas defined by the engagement of substantially flat surfaces.

4. The connector of claim 1, wherein at least one of said engagement areas is a tapered engagement area defined by the engagement of tapered surfaces.

5. The connector of claim 1, wherein all of said engagement areas are tapered engagement areas defined by the engagement of tapered surfaces.

6. The connector of claim 1, wherein said first end is threadingly coupled to said first component.

7. The connector of claim 1, wherein said first component is comprised of at least one of a blowout preventer, a riser, a production tree, a tubing head and a running tool.

8. The connector of claim 1, wherein said second component is comprised of at least one of a blowout preventer, a riser, a production tree, a tubing head and a running tool.

9. The connector of claim 1, further comprising at least one indicator rod that is operatively coupled to said locking mandrel and adapted to indicate a position of said locking mandrel.

10. The connector of claim 1, wherein each of said plurality of locking segments comprises:
a first primary locking shoulder that is adapted to engage a first surface on said first component; and
a second primary locking shoulder that is adapted to engage a second surface on said second component.

11. The connector of claim 10, wherein each of said plurality of locking segments further comprises:
a first secondary shoulder on said locking segment that is adapted to engage a first secondary shoulder on said first component; and
a second secondary shoulder on said locking segment that is adapted to engage a second secondary shoulder on said second component.

12. The connector of claim 10, wherein said first primary locking shoulder and said first surface on said first component are tapered surfaces.

13. The connector of claim 10, wherein said second primary locking shoulder and said second surface on said second component are tapered surfaces.

14. The connector of claim 1, wherein said locking mandrel comprises a plurality of recesses, each of which is adapted to receive a protrusion on said locking segments when said locking segments are in a disengaged position.

15. The connector of claim 1, wherein each of said locking segments is comprised of a downwardly facing surface that is adapted to engage an upwardly facing surface on said locking mandrel when said locking mandrel is actuated to disengage said connector.

16. The connector of claim 1, wherein said locking mandrel is operatively coupled to a primary piston.

17. The connector of claim 16, further comprising a secondary release piston positioned below said primary piston, said secondary release piston adapted to, when actuated, cause said primary piston to move.

18. A connector, comprising:
a first end adapted to be coupled to a first component;
a plurality of locking segments that, when actuated, are adapted to secure said first component to a second component; and
a locking mandrel that, when actuated, is adapted to engage each of said plurality of locking segments at at least two discrete, spaced apart substantially flat engagement areas.

19. The connector of claim 18, wherein said connector is engaged at at least three discrete, spaced apart substantially flat engagement areas.

20. The connector of claim 18, wherein said first end is threadingly coupled to said first component.

21. The connector of claim 18, wherein said first component is comprised of at least one of a blowout preventer, a riser, a production tree, a tubing head and a running tool.

22. The connector of claim 18, wherein said second component is comprised of at least one of a blowout preventer, a riser, a production tree, a tubing head and a running tool.

23. The connector of claim 18, further comprising at least one indicator rod that is operatively coupled to said locking mandrel and adapted to indicate a position of said locking mandrel.

24. The connector of claim 18, wherein each of said plurality of locking segments comprises:
a first primary locking shoulder that is adapted to engage a first surface on said first component; and
a second primary locking shoulder that is adapted to engage a second surface on said second component.

25. The connector of claim 24, wherein each of said plurality of locking segments further comprises:
a first secondary shoulder on said locking segment that is adapted to engage a first secondary shoulder on said first component; and
a second secondary shoulder on said locking segment that is adapted to engage a second secondary shoulder on said second component.

26. The connector of claim 24, wherein said first primary locking shoulder and said first surface on said first component are tapered surfaces.

27. The connector of claim 24, wherein said second primary locking shoulder and said second surface on said second component are tapered surfaces.

28. The connector of claim 18, wherein said locking mandrel comprises a plurality of recesses, each of which is adapted to receive a protrusion on said locking segments when said locking segments are in a disengaged position.

29. The connector of claim 18, wherein each of said locking segments is comprised of a downwardly facing surface that is adapted to engage an upwardly facing surface on said locking mandrel when said locking mandrel is actuated to disengage said connector.

30. The connector of claim 18, wherein said locking mandrel is operatively coupled to a primary piston.

31. The connector of claim 30, further comprising a secondary release piston positioned below said primary piston, said secondary release piston adapted to, when actuated, cause said primary piston to move.

32. A connector, comprising:
a first end adapted to be coupled to a first component;
a plurality of locking segments that, when actuated, are adapted to secure said first component to a second component; and
a locking mandrel that, when actuated, is adapted to engage each of said plurality of locking segments at three discrete, spaced apart, substantially flat engagement areas.

33. The connector of claim 32, wherein said first end is threadingly coupled to said first component.

34. The connector of claim 32, wherein said first component is comprised of at least one of a blowout preventer, a riser, a production tree, a tubing head and a running tool.

35. The connector of claim 32, wherein said second component is comprised of at least one of a blowout preventer, a riser, a production tree, a tubing head and a running tool.

36. The connector of claim 32, further comprising at least one connector rod that is operatively coupled to said locking mandrel and adapted to indicate a position of said locking mandrel.

37. The connector of claim 32, wherein each of said plurality of locking segments comprises:
a first primary locking shoulder that is adapted to engage a first surface on said first component; and
a second primary locking shoulder that is adapted to engage a second surface on said second component.

38. The connector of claim 37, wherein at least one of said substantially flat areas is axially positioned between said first and second primary shoulders and laterally offset therefrom.

39. The connector of claim 37, wherein each of said plurality of locking segments further comprises:
a first secondary shoulder on said locking segment that is adapted to engage a first secondary shoulder on said first component; and
a second secondary shoulder on said locking segment that is adapted to engage a second secondary shoulder on said second component.

40. The connector of claim 37, wherein said first primary locking shoulder and said first surface on said first component are tapered surfaces.

41. The connector of claim 37, wherein said second primary locking shoulder and said second surface on said second component are tapered surfaces.

42. The connector of claim 32, wherein said locking mandrel comprises a plurality of recesses, each of which is adapted to receive a protrusion on said locking segments when said locking segments are in a disengaged position.

43. The connector of claim 32, wherein each of said locking segments is comprised of a downwardly facing surface that is adapted to engage an upwardly facing surface on said locking mandrel when said locking mandrel is actuated to disengage said connector.

44. The connector of claim 32, wherein said locking mandrel is operatively coupled to a primary piston.

45. The connector of claim 44, further comprising a secondary release piston positioned below said primary piston, said secondary release piston adapted to, when actuated, cause said primary piston to move.

46. A connector, comprising:
a first end adapted to be coupled to a first component;
a plurality of locking segments that, when actuated, are adapted to secure said first component to a second component, wherein each of said plurality of locking segments comprises:
a first primary locking shoulder that is adapted to engage a first surface on said first component, and
a second primary locking shoulder that is adapted to engage a second surface on said second component; and
a locking mandrel that, when actuated, is adapted to engage each of said plurality of locking segments at three discrete, spaced apart, substantially flat engagement areas.

47. The connector of claim 46, wherein said first end is threadingly coupled to said first component.

48. The connector of claim 46, wherein said first component is comprised of at least one of a blowout preventer, a riser, a production tree, a tubing head and a running tool.

49. The connector of claim 46, wherein said second component is comprised of at least one of a blowout preventer, a riser, a production tree, a tubing head and a running tool.

50. The connector of claim 46, further comprising at least one connector rod that is operatively coupled to said locking mandrel and adapted to indicate a position of said locking mandrel.

51. The connector of claim 46, wherein each of said plurality of locking segments further comprises:
a first secondary shoulder on said locking segment that is adapted to engage a first secondary shoulder on said first component; and
a second secondary shoulder on said locking segment that is adapted to engage a second secondary shoulder on said second component.

52. The connector of claim 46, wherein said first primary locking shoulder and said first surface on said first component are tapered surfaces.

53. The connector of claim 46, wherein said second primary locking shoulder and said second surface on said second component are tapered surfaces.

54. The connector of claim 46, wherein said locking mandrel comprises a plurality of recesses, each of which is adapted to receive a protrusion on said locking segments when said locking segments are in a disengaged position.

55. The connector of claim 46, wherein each of said locking segments is comprised of a downwardly facing surface that is adapted to engage an upwardly facing surface on said locking mandrel when said locking mandrel is actuated to disengage said connector.

56. The connector of claim 46, wherein said locking mandrel is operatively coupled to a primary piston.

57. A connector, comprising:
a first end adapted to be coupled to a first component;
a plurality of means for securing said first component to a second component; and
means for engaging each of said means for securing said first component to said second component at at least three discrete, spaced apart engagement areas.

58. The connector of claim 57, wherein said plurality of means for securing said first component to said second component comprises a plurality of locking segments, each of which are adapted to, when actuated, engage said first and second components.

59. The connector of claim 57, wherein said means for engaging each of said means for securing said first component to said second component comprises a locking mandrel.

60. The connector of claim 57, further comprising a means for actuating said means for engaging each of said plurality of securing means.

61. The connector of claim 60, wherein said means for actuating said means for engaging comprises a piston operatively coupled to said means for engaging.

62. The connector of claim 57, further comprising a secondary release means for disengaging said means for engaging each of the means for securing said first component to said second component.

63. The connector of claim 62, wherein said secondary release means comprises a piston.

64. The connector of claim 57, wherein at least one of said engagement areas is a substantially flat engagement area defined by the engagement of substantially flat surfaces.

65. The connector of claim 57, wherein all of said engagement areas are substantially flat engagement areas defined by the engagement of substantially flat surfaces.

66. The connector of claim 57, wherein at least one of said engagement areas is a tapered engagement area defined by the engagement of tapered surfaces.

67. The connector of claim 57, wherein all of said engagement areas are tapered engagement areas defined by the engagement of tapered surfaces.

68. The connector of claim 57, wherein said first component is comprised of at least one of a blowout preventer, a riser, a production tree, a tubing head and a running tool.

69. The connector of claim 57, wherein said second component is comprised of at least one of a blowout preventer, a riser, a production tree, a tubing head and a running tool.
